(19) United States
(12) Patent Application Publication
(10) Pub. No.: US 2026/0127923 A1
(43) Pub. Date: May 7, 2026

(54) Lock Controlling Method

(71) Applicant: I-Ting Shen, Tainan (TW)

(72) Inventor: I-Ting Shen, Tainan (TW)

(21) Appl. No.: 18/964,627

(22) Filed: Dec. 1, 2024

(30) Foreign Application Priority Data
Nov. 1, 2024 (TW) 113141942

(51) Int. Cl. G07C 9/00

(52) U.S. Cl. CPC G07C 9/00182; G07C 9/00563

(57) ABSTRACT

A lock controlling method includes using a manager mobile device to obtain a control authority of a lock which may be set by the manager mobile device to a normal mode, a normally open mode, or a do-not-disturb mode. The manager mobile device may grant a use right of the lock to at least one user mobile device and at least one door access card. All of the manager mobile device, the user mobile device, and the door access card may be used to unlock the lock in the normal mode. When the lock is in the do-not-disturb mode, only the manager mobile device is permitted to unlock the lock. The lock in the normally open mode remains in an unlocking state. The lock may read a door access card identification information stored in a door access card to grant the use right to the door access card.

### BACKGROUND OF THE INVENTION

The present invention relates to a lock controlling method and, more particularly, to a method capable of changing the operation mode of a lock, unlocking the lock, and granting authority of the lock through a mobile device and/or a door access card.

A door lock installed on a door provides a door access control function. Door locks evolve from conventional mechanic type into current electric type. An electric door lock requires input of a password and/or a biological feature (such as a facial feature or a fingerprint feature). However, authorization and control of electric door locks are not convenient enough.

Furthermore, an electric door lock generally remains in a locking state and includes an outer operating device without a keyway. In a case that a solitary feels uncomfortable but is unable to unlock the door lock, it is difficult for a normal locksmith or an ambulance technician to crack the electric door lock. As a result, the help from the facilitator (such as the timing of medical treatment) could be delayed.

### BRIEF SUMMARY OF THE INVENTION

In a first aspect, the present invention provides a lock controlling method comprising:
using a manager mobile device to obtain a control authority of a lock to permit execution of an unlocking procedure on the lock, wherein the lock is preset to a normal mode and a locking state, wherein when the lock is not in an unlocking state, operation of an outer operating device of the lock is unable to retract a latch of the lock, and the latch is retractable by operating an inner operating device of the lock; and
using the manager mobile device to execute a mode selection procedure permitting the manager mobile device to be switched from the normal mode to a normally open mode, wherein the manager mobile device is used to connect with the lock whose control authority has been granted to the manager mobile device, wherein the mode selection procedure is canceled when connection between the manager mobile device and the lock is not established, wherein when connection between the manager mobile device and the lock is established, the manager mobile device 68 is usable to set the lock to one of the normal mode and the normally open mode,
wherein when the lock is set to the normally open mode, the lock starts countdown of a normally open mode retaining time period, wherein when the normally open mode retaining time period is not over, the lock0 maintains the normally open mode and the unlocking state, wherein when the normally open mode retaining time period ends, the lock returns from the normally open mode to the normal mode.

The normally open mode provided in the lock controlling method according to the present invention enables the lock to maintain the unlocking state for a period of time, such that an older person or a solitary in a house may seek help, and an ambulance technician or police may rapidly enter the house to provide timely assistance.

In an example, the mode selection procedure further includes a do-not-disturb (dnd) mode, permitting the manager mobile device to switch the lock from the normal mode to one of the dnd mode and the normally open mode. When the lock is set to the dnd mode and is in the locking state, the lock starts countdown of a dnd mode retaining time period. When the dnd mode retaining time period is not over, the lock in the dnd mode only permits the manager mobile device to execute the unlocking procedure for unlocking the lock. When the dnd mode retaining time period ends, the lock returns to the normal mode.

The dnd (do-not-disturb) mode provided in the lock controlling method according to the present invention permits a lock to be unlocked only when the unlocking procedure is executed by a manager mobile device granted with the control authority of the lock. Thus, when the holder of the manager mobile device needs privacy, the lock cannot be unlocked by devices other than the manager mobile device.

In an example, the lock controlling method further comprises using a door access card to execute the unlocking procedure. The door access card is granted with a use right of the lock. The lock reads a door access card identification information of the door access card and identifies whether the door access card identification information of the door access card is correct. When the door access card identification information of the door access card is incorrect and the lock is in either of the normal mode and the dnd mode, the lock remains in the locking state. When the door access card identification information of the door access card is incorrect and the lock is in the normally open mode, the lock remains in the unlocking state and gives a hint by sound and/or light to indicate that the door access card identification information of the door access card is identified as being incorrect. When the door access card identification information of the door access card is correct and the lock is in the normal mode, the lock is unlocked.

When the door access card identification information of the door access card is correct and the lock is in the dnd mode, the lock remains in the locking state. When the door access card identification information of the door access card is correct and the lock is in the normally open mode, the lock gives a hint by sound and/or light to indicate the normally open mode and remains in the unlocking state.

In an example, granting the use right includes:
using the manager mobile device to grant the use right to the door access card;
setting a name for the door access card;
using the manager mobile device to select the lock whose use right is to be granted to the door access card;
setting a time period of the use right to be granted to the door access card;
using the manager mobile device to select the lock to read the door access card, such that the lock selected to read the door access card generates a hint, wherein when the door access card is placed near the lock, the lock generating the hint reads the door access card identification information of the door access card and transmits the door access card identification information of the door access card to the manager mobile device;
using the manager mobile device to proceed with a synchronization procedure on the lock whose use right is to be granted, wherein the door access card does not obtain the use right of the lock before the synchronization procedure is completed, and wherein the door access card obtains the use right of the lock only after the synchronization procedure is completed.

By using the lock controlling method according to the present invention to grant the use right of the lock to the door access card, the outer operating device of the lock may directly read the card ID information of the door access card, such that the use right of the lock (unlocking the lock) can be granted to the door access card without using a computer and a card reader, which is more convenient to grant the use right to the door access card.

In an example, the lock controlling method further comprises:
using the manager mobile device to execute a use right cancellation procedure;
selecting the door access card, wherein a plurality of door access card identification informations associated with a plurality of locks is stored in the door access card;
selecting one of the plurality of locks whose door access card identification information is to be cancelled;
identifying whether the selected lock is within a wireless communication range of the manager mobile device, wherein when the selected lock is not within the wireless communication range of the manager mobile device, the door access card still owns the use right of the selected lock, and wherein when the selected lock is within the wireless communication range of the manager mobile device, is connected with the manager mobile device, and is synchronized with the manager mobile device, the use right of the selected lock is cancelled from the door access card.

In an example, the lock controlling method further comprises:
using a user mobile device to execute the unlocking procedure, wherein the user mobile device is granted with a use right of the lock;
wherein with the user mobile device not connected with the lock, the lock remains in the locking state when in either of the normal mode and the dnd mode or remains in the unlocking state when in the normally open mode,
wherein with the user mobile device connected with the lock and with the user mobile device set to a single authentication procedure in which input of an authentication identification information is requested, when identification of the inputted authentication identification information is unsuccessful, the lock remains in the unlocking state when in either of the normal mode and the dnd mode or remains in the unlocking state when in the normally open mode,
wherein when the inputted authentication identification information is identified as being correct or the authentication identification information is not required, the lock is switched to the unlocking state when in the normal mode, or remains in the unlocking state and gives a hint to indicate the unlocking state when in the normally open mode, or remains in the locking state when in the dnd state.

In an example, granting the use right to the user mobile device includes:
using the user mobile device to complete registration of an account of the user mobile device;
using the manager mobile device to input an account or using the manager mobile device to scan a QR code displayed by the user mobile device, wherein when the account inputted by the manager mobile device or the QR code scanned by the manager mobile device is incorrect, the use right of the lock is not granted to the user mobile device, wherein when the account inputted by the manager mobile device or the QR code scanned by the manager mobile device is correct, the manager mobile device grants the use right of the lock to the user mobile device.

In an example, the lock controlling further comprises:
using the manager mobile device to execute a control authority transfer procedure including:
inputting an account name of another mobile device to which the control authority is to be transferred;
selecting a lock whose control authority is to be transferred;
requesting input of an authentication identification information for execution of an authentication procedure, wherein when the authentication is unsuccessful, the control authority is not transferred to the another mobile device, wherein when the authentication is successful, the control authority is transmitted to the another mobile device;
wherein when a holder of the user mobile device does not agree with transfer of the control authority or has not agreed with transfer of the control authority, the manager mobile device keeps the control authority of the selected lock,
wherein when the holder of the user mobile device agrees with transfer of the control authority, the transfer of control authority of the selected lock is successfully transferred from the manager mobile device to the user mobile device, and the lock loses the control authority of the selected lock.

Transfer of the control authority of the lock (whose control authority has been granted to the manager mobile device) according to the present invention is relatively convenient, and the manager mobile device can still cancel transfer of control authority before the holder of the mobile device agrees with the transfer, providing certain fault-tolerance during the control authority transfer operation.

In an example, the manager mobile device obtains the control authority of the lock by:
using the manager mobile device to select a control authority adding procedure;
operating the lock to enter a state permitting access to the control authority;
using the manager mobile device to search whether the lock is within the wireless communication range of the manager mobile device, wherein the control authority of the lock is not granted to the manager mobile device when the lock is not within the wireless communication range;
wherein when the lock is within the wireless communication range, the manager mobile device is used to select the lock whose control authority is to be granted to the manager mobile device, wherein the manager mobile device is used to input an identification number, wherein when the inputted identification number does not match with a unique identification number of the lock, the control authority is not granted to the manager mobile device, and wherein when the when the inputted identification number matches with the unique identification number of the lock, the control authority is granted to the manager mobile device.

In an example, the lock controlling method further comprises:
using the manager mobile device to execute the unlocking procedure includes:
using the manager mobile device to identify whether the lock is connected with the manager mobile device, wherein when the lock is not connected with the manager mobile device, the lock remains in the locking state when in either of the normal mode and the dnd mode or remains in the unlocking state when in the normally open mode,
wherein when the lock is connected with the manager mobile device which is set to require input of an authentication information, the manager mobile device is used to input the authentication information, wherein when the inputted authentication information is identified as being incorrect, the lock remains in the locking state when in either of the normal mode and the dnd mode or remains in the unlocking state when in the normally open mode,
wherein when the inputted authentication information is identified as being correct and the lock is in the normal mode, the manager mobile device transmits a control signal to the lock, wherein when the lock identifies that the control signal is correct, the lock is switched to the unlocking state,
wherein when the inputted authentication information is identified as being correct and the lock is in the dnd mode, the manager mobile device gives a hint to indicate that the lock is in the dnd mode, and the manager mobile device requests input of determination of whether to continue the execution of the unlocking procedure, wherein when it is determined to continue the execution of the unlocking procedure, the lock is switched to the unlocking state, wherein when it is determined not to continue the execution of the unlocking procedure, the lock remains the locking state,
wherein when the inputted authentication information is identified as being correct and the lock is in the normally open mode, the manager mobile device gives a hint to indicate that the lock is in the normally open mode.

In another aspect, the present invention provides a lock controlling method comprising:
using a manager mobile device to obtain a control authority of a lock to permit execution of an unlocking procedure on the lock, wherein the lock is preset to a normal mode and a locking state, wherein when the lock is not in an unlocking state, operation of an outer operating device of the lock is unable to retract a latch of the lock, and the latch is retracted by operating an inner operating device of the lock; and
using the manager mobile device to execute a mode selection procedure permitting the manager mobile device to be switched from the normal mode to a do-not-disturb (dnd) mode, wherein the manager mobile device is used to connect with the lock whose control authority has been granted to the manager mobile device, wherein the mode selection procedure is canceled when connection between the manager mobile device and the lock is not established, wherein when connection between the manager mobile device and the lock is established, the manager mobile device is usable to set the lock to one of the normal mod and the dnd mode,
wherein when the lock is set to the dnd mode and remains in the locking state, the lock starts countdown of a dnd mode retaining time period, wherein when the dnd retaining time period is not over, the lock maintains the dnd mode and only permits execution of the unlocking procedure by the manager mobile device, wherein when the dnd mode retaining time period ends, the lock returns from the dnd mode to the normal mode.

The dnd (do-not-disturb) mode provided in the lock controlling method according to the present invention permits a lock to be unlocked only when the unlocking procedure is executed by a manager mobile device granted with the control authority of the lock. Thus, when the holder of the manager mobile device needs privacy, the lock cannot be unlocked by devices other than the manager mobile device.

In an example, the lock controlling method further comprises using a door access card to execute the unlocking procedure. The door access card is granted with a use right of the lock. The lock reads a door access card identification information of the door access card and identifies whether the door access card identification information of the door access card is correct. When the door access card identification information of the door access card is incorrect and the lock is in either of the normal mode and the dnd mode, the lock remains in the locking state. When the door access card identification information of the door access card is correct and the lock is in the normal mode, the lock is switched to the unlocking state. When the door access card identification information of the door access card is correct and the lock is in the dnd mode, the lock remains in the locking state.

In an example, the lock controlling method further comprises:
using a user mobile device to execute the unlocking procedure, wherein the user mobile device is granted with a use right of the lock,
wherein with the user mobile device not connected with the lock, the lock remains in the locking state when in either of the normal mode and the dnd mode or remains in the unlocking state when in the normally open mode,
wherein with the user mobile device connected with the lock and with the user mobile device set to a single authentication procedure in which an authentication identification information is to be inputted, when identification of the inputted authentication identification information is unsuccessful, the lock remains in the locking state when in either of the normal mode and the dnd mode,
wherein when the inputted authentication identification information is identified as being correct or the authentication identification information is not required, the lock is switched to the unlocking state when in the normal mode or remains in the locking state when in the dnd state.

In a further aspect, the present invention provides a lock controlling method comprising:
using a manager mobile device to grant a control authority of a first lock and a control authority of a second lock;
using the manager mobile device to grant a use right to a door access card;
setting a name for the door access card;
using the manager mobile device to select at least one of the first lock and the second lock whose control authority is to be granted to the door access card;
using the manager mobile device to select the first lock or the second lock as a device for reading a door access card identification information of the door access card, wherein the selected one of the first and second locks gives a hint indicative of a result of selection, wherein when the door access card is near the selected one of the first and second locks, the selected one of the first and second locks reads the door access card identification information of the door access card and transmits the door access card identification information of the door access card to the manager mobile device;
using the manager mobile device to proceed with a synchronization procedure on at least one of the first and second locks whose use right is to be granted, wherein the door access card is granted with the use right of at least one of the first and second locks only when the synchronization procedure is completed on the manager mobile device and the at least one of the first and second locks.

By using the lock controlling method according to the present invention to grant the use right of the lock to the door access card, the outer operating device of the lock may directly read the card ID information of the door access card, such that the use right of the lock (unlocking the lock) can be granted to the door access card without using a computer and a card reader, which is more convenient to grant the use right to the door access card.

In an example, the lock controlling method further comprises:
using the manager mobile device to execute a mode selection procedure permitting the manager mobile device to be switched from the normal mode to a normally open mode or a do-not-disturb (dnd) mode, wherein the manager mobile device is used to connect with one of the first and second locks whose control authority has been granted to the manager mobile device, wherein the mode selection procedure is canceled when connection between the manager mobile device and the one of the first and second locks is not established, wherein when connection between the manager mobile device and the one of the first and second locks is established, the manager mobile device is usable to switch the one of the first and second locks from the normal mode to one the normally open mode and the dnd mode,
wherein with the first and second locks set to the normal mode, when the first and second locks are not in an unlocking state, operation of an outer operating device of either of the first and second locks is unable to retract a latch of a respective one of the first and second locks, and the latch is retractable by operating an inner operating device of the respective one of the first and second locks;
wherein when one of the first and second locks is set to the normally open mode, the one of the first and second locks starts countdown of a normally open mode retaining time period, wherein when the normally open mode retaining time period is not over, the one of the first and second locks maintains the normally open mode, wherein when the normally open mode retaining time period ends, the one of the first and second locks returns from the normally open mode to the normal mode,
wherein when one of the first and second locks is set to the dnd mode, the one of the first and second locks starts countdown of a dnd mode retaining time period, wherein when the dnd mode retaining time period is not over, the one of the first and second locks maintains the dnd mode, wherein when the dnd mode retaining time period ends, the one of the first and second locks returns from the dnd mode to the normal mode,
wherein when the door access card is used to execute an unlocking procedure, the selected one of the first and second locks reads and identifies the door access card identification information of the door access card,
wherein when the door access card identification information of the door access card is identified as being correct and the selected one of the first and second locks is set to the normal mode, the selected one of the first and second locks is switched to the unlocking state, such that the latch of the selected one of the first and second locks is retractable by operating either of the outer operating device and the inner operating device of the selected one of the first and second locks,
wherein when the door access card identification information of the door access card is identified as being correct and the selected one of the first and second locks is set to the dnd mode, operation of the outer operating device of the selected one of the first and second locks is unable to retract the latch of the selected one of the first and second locks, but operation of the inner operating device retracts the latch of the selected one of the first and second locks,
wherein when the door access card identification information of the door access card is identified as being correct and the selected one of the first and second locks is set to the normally open mode, the selected one of the first and second locks generates sound and/or light to indicate that the selected one of the first and second locks is in the normally open mode, wherein the latch of the selected one of the first and second locks is retractable by operating either of the outer operating device and the inner operating device of the selected one of the first and second locks.

In an example, using the manager mobile device to execute the unlocking procedure includes:
using the manager mobile device to identify whether one of the first and second locks is connected with the manager mobile device, wherein when the selected one of the first and second locks is not connected with the manager mobile device, the one of the first and second locks remains in the locking state when in either of the normal mode and the dnd mode or remains in the unlocking state when in the normally open mode,
wherein when the one of the first and second locks is connected with the manager mobile device which is set to require input of an authentication information, the manager mobile device is used to input the authentication information, wherein when the inputted authentication information is identified as being incorrect, the one of the first and second locks remains in the locking state when in either of the normal mode and the dnd mode or remains in the unlocking state when in the normally open mode,
wherein when the inputted authentication information is identified as being correct and the one of the first and second locks is in the normal mode, the manager mobile device transmits a control signal to the one of the first and second locks, wherein when the lock identifies that the control signal is correct, the one of the first and second locks is switched to the unlocking state,
wherein when the inputted authentication information is identified as being correct and the one of the first and second locks is in the dnd mode, the manager mobile device gives a hint to indicate that the one of the first and second locks is in the dnd mode, and the manager mobile device requests input of determination of whether to continue the execution of the unlocking procedure, wherein when it is determined to continue the execution of the unlocking procedure, the manager mobile device sends a control signal to the one of the first and second locks, wherein the one of the first and second locks is switched to the unlocking state when the control signal is identified as being correct, wherein when it is determined not to continue the execution of the unlocking procedure, the one of the first and second locks in the dnd mode remains the locking state,
wherein when the inputted authentication information is identified as being correct and the one of the first and second locks is in the normally open mode, the manager mobile device gives a hint to indicate that the one of the first and second locks is in the normally open mode.

The present invention will become clearer in light of the following detailed description of illustrative embodiments of this invention described in connection with the drawings.

### DESCRIPTION OF THE DRAWINGS

FIG. 1 is a schematic flowchart illustrating obtaining control authority of a lock by a manager mobile device by a method according to the present invention.

FIG. 2 is a schematic diagram illustrating the functions executable after obtaining the control authority of the lock by the manager mobile device.

FIG. 3 is a schematic flowchart illustrating use of the manager mobile device to grant use right to a user mobile device and a door access card.

FIG. 4 is a schematic flowchart illustrating use of the manager mobile device to cancel the use right of the lock from the user mobile device and the door access card.

FIG. 5 is a schematic flowchart illustrating use of the manager mobile device to change the authentication procedure required to be executed by the manager mobile device or the user mobile device for carrying out an unlocking procedure.

FIG. 6 is a schematic flowchart illustrating use of the manager mobile device to change the lock to a do-not-disturb mode or a normally open mode.

FIG. 7 is a schematic flowchart illustrating whether the lock returns from the do-not-disturb mode to the normal mode.

FIG. 8 is a schematic flowchart illustrating whether the lock returns from the normally open mode to the normal mode.

FIG. 9 is a schematic flowchart illustrating use of a mobile device and a door access card to execute an unlocking procedure on a lock.

FIG. 10 is a schematic view illustrating use of a manager mobile device to transfer the control right of the manager mobile device to another mobile device.

FIG. 11 is a schematic diagram illustrating an example of a hardware device required for executing the lock controlling method according to the present invention.

FIG. 12 is a schematic diagram illustrating use of the lock controlling method according to the present invention to control plural locks.

All figures are drawn for ease of explanation of the basic teachings of the present invention only; the extensions of the figures with respect to number, position, relationship, and dimensions of the parts to form the embodiments will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

Where used in the various figures of the drawings, the same numerals designate the same or similar parts. Furthermore, when the terms “first”, “second”, and similar terms are used herein, it should be understood that these terms have reference only to the structure shown in the drawings as it would appear to a person viewing the drawings and are utilized only to facilitate describing the invention.

### DETAILED DESCRIPTION OF THE INVENTION

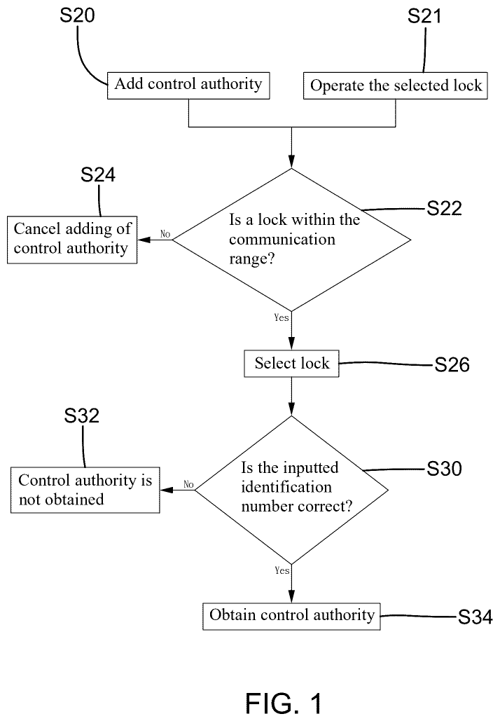

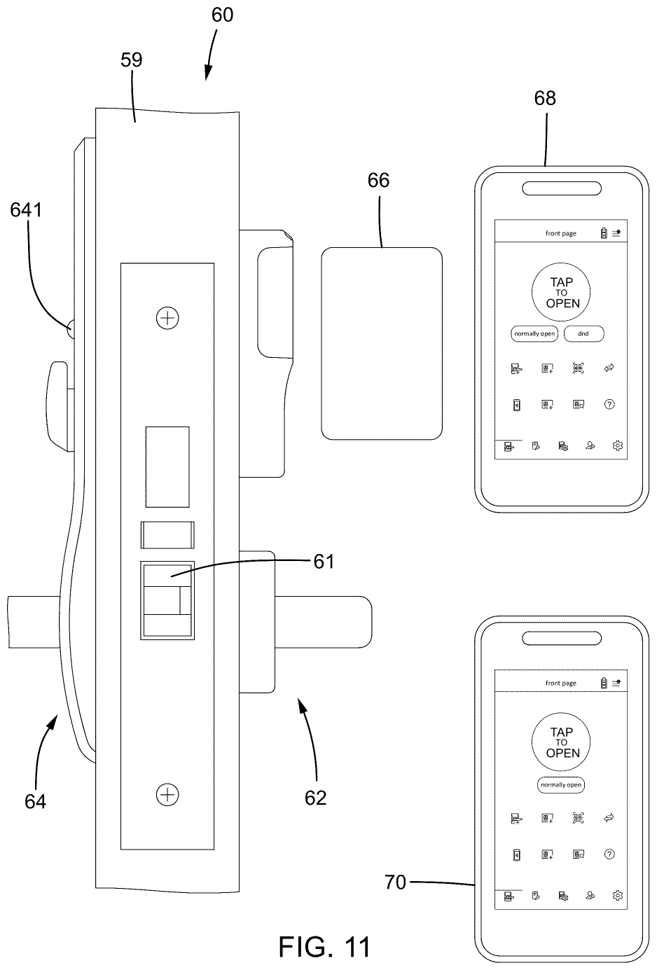

The present invention relates to a lock controlling method. With reference to FIG. 11, the lock controlling method may be carried out under the cooperation of a lock 60, at least one door access card 66, a manager mobile device 68, and at least one user mobile device 70. The lock 60 shown in FIG. 11 may be but not limited to a door lock installed on a door 59. The lock 60 includes an outer operating device 62 located on an outer side of the door 59 and an inner operating device 64 located on an inner side of the door 59. The inner operating device 64 includes two physical buttons 641 (only one can be seen in FIG. 1). The outer operating device 62 may read a door access card identification information (hereinafter referred to as “card ID information”) stored in a door access card 66. The lock 60 may further include a latch 61. Regardless of the state (locking state or unlocking state) of the lock 60, the inner operating device 64 can be operated to retract the latch 61, thereby allowing opening of the door 59. The outer operating device 62 can be operated to retract the latch 61 only when the lock 60 is in the unlocking state. When the lock 60 is in the locking state, the outer operating device 62 is unable to retract the latch 61, thereby prohibiting opening of the door 59.

The door access card 66 (or each door access card 66, if plural door access cards 66 is used) may be but not limited to use a wireless connection technique, such as radio frequency identification (RFID) or near filed communication (NFC). The outer operating device 62 can read a card ID information stored in the door access card 66 in use and can identify whether the door access card 66 has obtained the use right or not, thereby determining whether the lock 60 should be unlocked. An application (hereinafter referred to as “APP”) is installed on each of the manager mobile device 68 and the at least one user mobile device 70. The manager mobile device 68 may obtain the control authority of the lock 60 via the APP. The manager mobile device 68 is permitted to unlock the lock 60 via the APP and to grant the use right of the lock to the door access card 66 and the user mobile device 70, such that the door access card 66 and the user mobile device 70 may be used to unlock the lock 60.

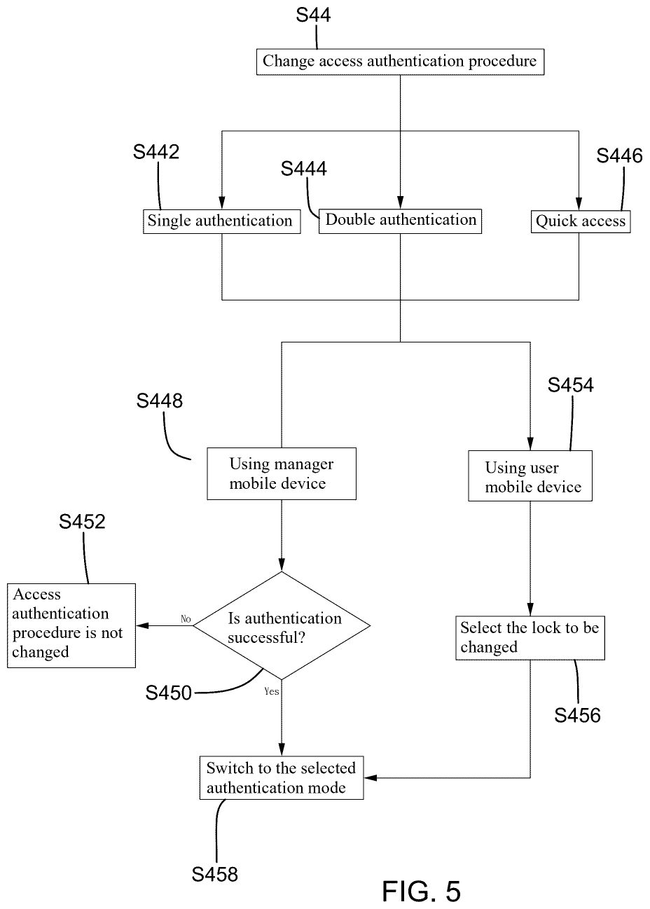

With reference to FIG. 1, a manager mobile device 68 on which the APP is installed is permitted to obtain the control authority of the lock 60 via the flowchart illustrated in FIG. 1. Specifically, the APP is firstly installed on the manager mobile device 68. Under guidance of an interface of the executed APP, an account can be registered, and a password can be set. Furthermore, the APP may be used to guide a holder of the manager mobile device 68 to input a biological feature of the holder of the manager mobile device 68. For example, the APP installed on the manager mobile device 68 may request input of a facial feature and/or a fingerprint feature. In a non-restrictive embodiment, the manager mobile device 68 may read the biological feature stored in the manager mobile device 68 after obtaining permission of the holder of the manager mobile device 68. For example, the manager mobile device 68 is an iPhone 15 having Face ID function. When the manager mobile device 68 is turned on, the APP installed on the manager mobile device 68 (the iPhone 15 in this embodiment) can directly read the facial feature stored in the iPhone 15 under permission of the holder. The manager mobile device 68 may be used to carry out one or more various access authentication procedures according to various combinations of the password, the facial feature, the fingerprint feature, etc. As an example, FIG. 5 shows a single authentication procedure, a double authentication procedure, and a quick access procedure.

In a case that the manager mobile device 68 is required to obtain the control authority of a lock 60, the manager mobile device 68 executes the APP and selects a procedure of adding control authority (step S20). Furthermore, the two physical buttons 641 on the inner operating device 64 of the lock 60 are simultaneously pressed (such as for about 5 seconds), such that the lock 60 enters a state permitting access to the control authority (“operate the selected lock”, see step S21). In step S22, it is identified whether a lock 60 (whose control authority has not been granted to the manager mobile device 68) is located within a wireless communication range of the manager mobile device 68. The lock 60 may be but not limited to include a Bluetooth device. The procedure of “adding control authority” may be selected via the interface of the APP installed on the manager mobile device 68, such as the icon of “add door lock” on the manager mobile device 68 illustrated in FIG. 11. When the procedure of “adding control authority” is started, the APP uses a Bluetooth device of the manager mobile device 68 to search whether any lock 60 is within the wireless communication range.

When no locks 60 are found in the wireless communication range of the manager mobile device 68, the manager mobile device 68 cannot obtain the control authority of any locks 60 (“cancel adding of control authority” see step S24). For example, the APP uses the Bluetooth device of the manager mobile device 68 to search whether any connectable lock 60 is within the Bluetooth communication range of the Bluetooth device. When no locks 60 are within the Bluetooth communication range of the manager mobile device 68, the APP will not guide the manager mobile device 68 to obtain the control authority of the lock 60.

On the other hand, when the manager mobile device 68 finds that a lock 60 is within the wireless communication range and is connected to the lock 60, the interface of the APP of the manager mobile device 68 may be used to select the lock 60 whose control authority has not been granted to the manager mobile device 68 (see step S26).

It is noted that the physical buttons 641 may be disposed on the inner operating device 64. Since the inner operating device 64 is located on the inner side (indoor) of the door 59, it is difficult for a person outside of the door 59 to access the physical buttons 641 installed on the inner operating device 64, thereby increasing the safety of the lock 60. Namely, it is difficult for the person outside the door 60 to obtain the control authority of the lock 60.

When the lock 60 enters a state permitting access to the control authority and is connected with the manager mobile device 68, the manager mobile device 68 is used to input a unique identification number of the lock 60 for obtaining the control authority. Specifically, in step S30, it is identified whether the inputted identification number is correct. When the inputted identification number is incorrect, the control authority cannot be granted to the manager mobile device 68 (step S32). On the other hand, when the inputted identified number is correct, the control authority is granted to the manager mobile device 68 (step S34).

Particularly, the lock manufacturer sets a unique identification number for each lock 60. The identification number (hereinafter referred to as “ID”) may be but not limited to be written into the firmware of the lock 60. Furthermore, the ID may be set forth in a QR code in the specification or the product card. Alternatively, the ID may be a combination of numerals and/or English alphabets. The holder of the manager mobile device 68 may obtain the ID (required for obtaining the control authority of the lock 60) from the specification or the product card and may input the ID via the interface of the APP of the manager mobile device 68. When the inputted ID is different from the ID stored in the firmware of the lock 60 connected with the manager mobile device 68, the manager mobile device 68 cannot obtain the control authority of the lock 60. On the other hand, when the inputted ID is the same as the ID stored in the firmware of the lock 60 connected with the manager mobile device 68, the manager mobile device 68 can obtain the control authority of the lock 60.

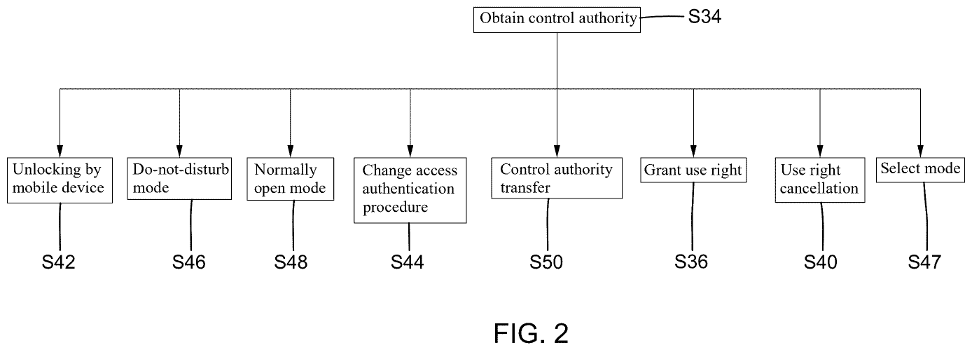

With reference to FIG. 2, after the manager mobile device 68 obtains the control authority of the lock 60, the manager mobile device 68 obtains functions of executing an unlocking procedure on the lock 60 (step S42), controlling the lock 60 to enter a do-not-disturb (hereinafter referred to as “dnd”) mode (step S46), controlling the lock 60 to enter a normally open mode (step S48), changing the access authentication procedure (step S44), selecting transfer of control authority (step S50), granting use right (step S36), cancelling use right (step S40), and selecting mode (step S47), all of which will be described hereinafter.

The manager mobile device 68 that has obtained the control authority of the lock 60 can grant the use right to at least one door access card 66 and/or at least one user mobile device 70 via the APP (step S36). Specifically, when the manager mobile device 68 grants the use right to a user mobile device 70, the APP must be installed on the user mobile device 70 beforehand, and a user uses the user mobile device 70 to register an account and logs in the APP installed on the user mobile device 70 (S362). Although the user mobile device 70 uses the registered account to log in the APP, the user mobile device 70 in this state is still without the use right (for unlocking purposes) of the lock 60.

Furthermore, the interface of the APP installed on the user mobile device 70 (which has logged in the APP) will guide the holder of the user mobile device 70 to input the password set by the holder and the biological feature of the holder. The biological feature may be but not limited to be comprised of a fingerprint and/or a facial feature. In a non-restrictive embodiment, the user mobile device 70 may directly read the biological feature stored in the user mobile device 70 after permission of the holder of the user mobile device 70. For example, the user mobile device 70 is an iPhone 15 with Face ID function. When the iPhone 15 is turned on, the iPhone 15 requests input of the biological feature of the holder, such that the APP of the user mobile device 70 comprised of the iPhone 15 permits the holder to directly read the biological feature (such as a facial feature) stored in the iPhone 15. The user mobile device 70 may be used to carry out one or more of various access authentication procedures according to various combinations of the password, the facial feature, and the fingerprint feature set by the APP. As an example, FIG. 5 shows a single authentication procedure, a double authentication procedure, and a quick access procedure.

In a case that the user mobile device 70 is located beside the manager mobile device 68 (proximal end authorization, see step S364), a QR code may be displayed on the screen of the user mobile device 70 through use of the interface of the APP installed on the user mobile device 70. The manager mobile device 68 may use the interface of the APP installed on the manager mobile device 68 to scan the QR code on the user mobile device 70. In step S366, it is identified whether scanning of the QR code is successful. When the scanning is not successful, the manager mobile device 68 will not grant the use right of the lock 60 to the user mobile device 70 (step S368).

On the other hand, when the scanning is successful, the manager mobile device 68 will grant the use right of the lock 60 to the user mobile device 70. Specifically, when the scanning is successful, the interface of the APP installed on the manager mobile device 68 will show the informations of all locks whose control authorities are owned by the manager mobile device 68, and the manager mobile device 68 can be used to select the lock 60 whose use right will be granted to the user mobile device 70 (step S375). After the manager mobile device 68 is used to select the lock 60 whose use right is to be granted to the user mobile device 70, the manager mobile device 68 sends data associated with the use right of the selected lock 60 to the user mobile device 70. Thus, the user mobile device 70 obtains the use right of the selected lock 60 (step S390) via proximal end authorization. Therefore, the user mobile device 70 is permitted to unlock the selected lock 60 via the interface of the APP installed on the user mobile device 70.

In a case that the manager mobile device 68 owns the control authorities of plural locks 69, when the manager mobile device 68 is used to select the locks 60 whose use rights are to be granted, the manager mobile device 68 may send the data of all of the selected locks 60 to the user mobile device 70 at the same time, such that the user mobile device 70 may obtain the use rights of all of the selected locks 60 at the same time.

In a case that the user mobile device 70 is not beside the manager mobile device 68, the manager mobile device 68 may be used to manually input the registered account of the user mobile device 70 (distal end authorization, see step S370). In step S372, it is identified whether the inputted account (account name or number) is correct. When the inputted account is incorrect, the manager mobile device 68 does not grant the use right of the lock 60 to the user mobile device 70 (step S374).

On the other hand, when the inputted account is correct, the interface of the APP installed on the manager mobile device 68 will show the informations of all locks whose control authorities are owned by the manager mobile device 68, and the manager mobile device 68 can be used to select the lock 60 whose use right will be granted to the user mobile device 70 (step S375). After the manager mobile device 68 is used to select the lock 60 whose use right is to be granted to the user mobile device 70, the manager mobile device 68 sends the data associated with the use right of the selected lock 60 to the user mobile device 70. Thus, the user mobile device 70 obtains the use right of the selected lock 60 (step S390) via distal end authorization. Therefore, the user mobile device 70 is permitted to unlock the selected lock 60 via the interface of the APP installed on the user mobile device 70.

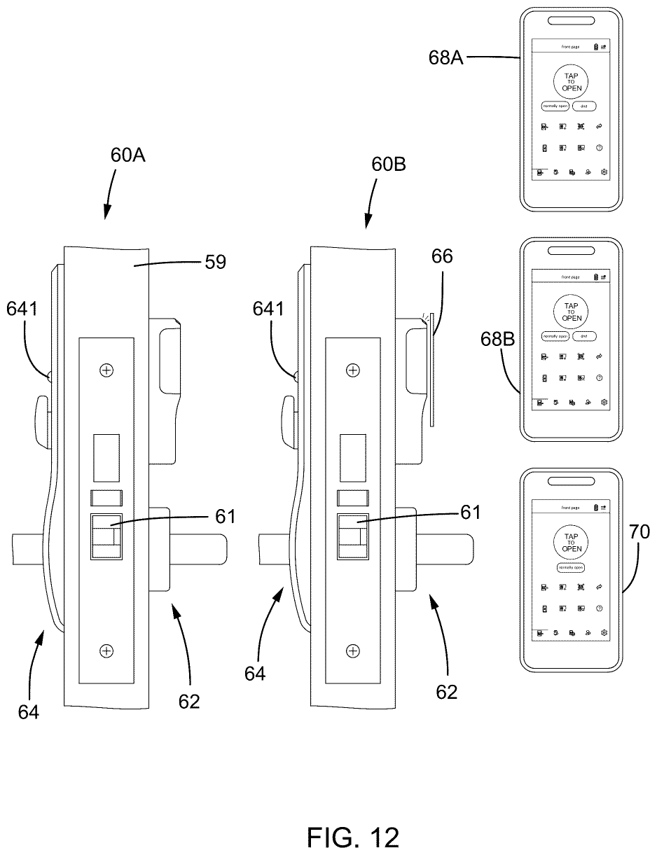

It is noted that the use right may be granted to the above-mentioned manager mobile device (hereinafter referred to as “first manager mobile device 68A”) by another manager mobile device (hereinafter referred to as “second manager mobile device 68B”). With reference to FIG. 12, for example, the first manager mobile device 68A obtains the control authority of a first lock 60A and grants the use right to a user mobile device 70. The second manager mobile device 68B obtains the control authority of a second lock 60B and may grant the use right of the second lock 60B to the first manager mobile device 68A and/or the user mobile device 70. The first manager mobile device 68A may manage (including executing the unlocking procedure) of the first lock 60A and may execute the unlocking procedure of the second lock 60B. Nevertheless, the first manager mobile device 68 cannot manage the first lock 60B, but the second manager mobile device 68 can manage the second lock 60B.

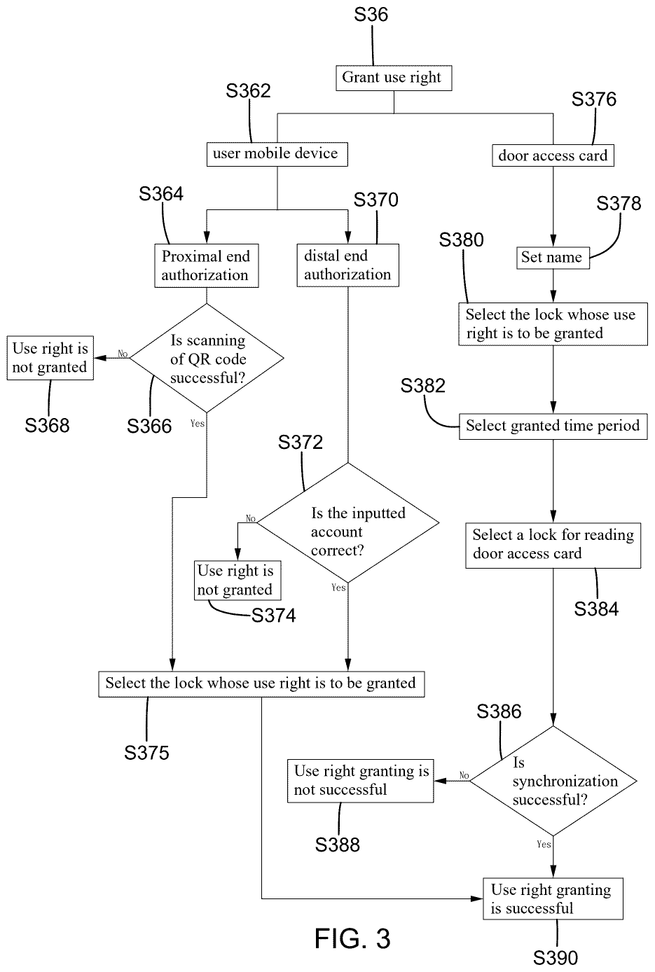

When it is desired to use the manager mobile device 68 to grant the use right of at least one lock 60 to a door access card 66 (step S376, see FIG. 3), the interface of the APP installed on the manager mobile device 68 selects an icon (“add new card”) and sets a name representing the door access card 66 to be granted with the use right of a to-be-selected lock 60 (step S378). For example, the name representing the door access card 66 may be the name or code name of the holder of the door access card 66. After the name representing the door access card 66 is set, the interface of the APP installed on the manager mobile device 68 will show the informations of all locks whose control authorities are owned by the manager mobile device 68. For example, the APP installed on the manager mobile device 68 shows the information of a door lock of a living room on the first floor and the information of a door lock of a master bedroom on the second floor. The holder of the manager mobile device 68 may select at least one of the locks 60 whose use right will be granted to the door access card 66 (step S380). Then, the APP installed on the manager mobile device 68 displays the options of time period of the use right to be granted to the door access card 66, such as permanent and optional, including the start date, start time, end date, and end time (step S382).

After the time period (such as from Oct. 30, 2024 to Dec. 30, 2024 or permanent) of the use right to be granted to the door access card 66 is set, the manager mobile device 68 searches the lock 60 within the wireless communication range, creates connection with the lock 60, and may be used as a device for reading information in the door access card 66. In step S384, a lock 60 for reading the door access card 66 is selected. The lock 60 selected to read the door access card 66 will give a hint, such as generating sound and/or lighting an indicating lamp. Particularly, when the door access card 66 abuts the outer operating device 62 of the selected lock 60, the selected lock 60 reads the card ID information of the door access card 66. In a case that the use right of the lock 60 is to be granted to plural door access cards 66 at a time, the selected lock 60 may read the card ID informations of the plural door access cards 66, and the card ID informations will be transmitted back to the manager mobile device 68 via a wireless approach (such as Bluetooth). In a non-restrictive embodiment, the lock 60 may read the card ID information of the door access card 66 and then may delete the card ID information after sending the card ID information to the manager mobile device 68.

In step S386, it is identified whether synchronization is successful. Specifically, after the selected lock 60 successfully reads the card ID information of the door access card 66, if the selected lock 60 is not within the wireless communication range of the manager mobile device 68 after searching, the synchronization is not successful (step S388), such that the door access card 66 still cannot be used to unlock the lock 60. In another case that the manager mobile device 68 is connected with the lock 60 (whose use right has been granted to the door access card 66) within the wireless communication range, but the synchronization is not carried out (namely, the synchronization is not successful, see step S388), the door access card 66 still cannot be used to unlock the lock 60.

In a case that the manager mobile device 68 is connected with the lock 60 whose use right is to be granted to the door access card 66, when the card ID information of the door access card 66 is smoothly transmitted by the manager mobile device 68 to the lock 60 and is stored in the lock 60, the manager mobile device 68 and the lock 60 (whose use right is to be granted to the door access card 66) are synchronized, such that the door access card 66 obtains the use right of the lock 60 and, thus, may be used to unlock the lock 60 (use right granting is successful, see step S390).

It is noted that when granting the use right to the door access card 66, a door lock 60 reading the card ID information of the door access card 66 may or may not be the lock 60 whose use right is to be granted to the door access card 66. In either case, the synchronization must be carried out on the manager mobile device 68 and the door access card 66 to be granted with the use right of the lock 60.

In the synchronization of the use right granting procedure, the card ID information of the door access card 66 is transmitted through the manager mobile device 68 to the lock 60 (whose use right is to be granted to the door access card 66). The synchronization needs not to be finished in the beginning. For example, in a case that a lock 60 (designated to read the door access card 66) has read the card ID information of the door access card 66, the manager mobile device 68 can be connected with the lock 60 (whose use right is to be granted) within an hour, and the synchronization is then carried out to transmit the information of the door access card 66 to the lock 60 to thereby store the information.

With reference to FIG. 12, in order to explain the use right granting procedure of a door access card 66, an example of a manager mobile device 68 owning the control authority of a first lock 60A and a second lock 60B will be set forth, wherein the first lock 60A is to be granted with the use right of a door access card 66. Specifically, the manager mobile device 68 is used to set a name for a door access card 66 (hereinafter referred to as “visitor card”) and to select the first lock 60A whose use right is to be granted to the visitor card. Then, the APP installed on the manager mobile device 68 is used to set the time period of the use right of the first lock 60A granted to the visitor card. Next, the manager mobile device 68 is used to select the second lock 60B as the lock for reading the card ID information of the door access card 66, and the second lock 60B will generate light and sound as a hint. Then, door access card 66 is moved to a place near the outer operating device 62 of the second lock 60B. The second lock 60B reads and transmits the card ID information of the door access card 66 to the manager mobile device 68. The second lock 60B does not keep the card ID information of the door access card 66. After reception of the card ID information sent by the second lock 60B, the manager mobile device 68 is connected with the first lock 60A and sends the card ID information of the door access card 66 to the first lock 60A which stores the card ID information. Thus, the door access card 66 obtains the use right of the first lock 60A but not the use right of the second lock 60B.

It can be appreciated that when the manager mobile device 68 selects both the first and second locks 60A and 60B (the use right of both the first and second locks 60A and 60B will be granted to the door access card 66), after reception of the card ID information sent by the second lock 60B, the manager mobile device 68 sends the card ID information of the door access card 66 to the first and second lock 60A and 60B each of which stores the card ID information. Thus, the door access card 66 obtains the use rights of the first and second locks 60A and 60B.

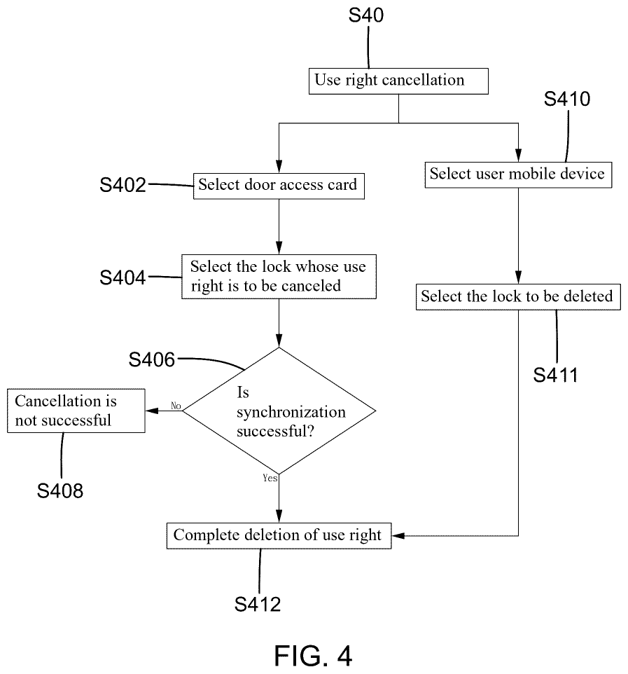

The information (such as the account name) of each user mobile device 70 and the card ID information of each door access card 66 are recorded by the APP installed on the manager mobile device 68. Thus, the manager mobile device 68 may be used to cancel the use right of a selected user mobile device 70 and the user right of a selected door access card 66. With reference to FIG. 4, when the manager mobile device 68 is used to cancel the use right from a user mobile device 70 (step S40), the interface of the APP installed on the manager mobile device 68 is used to select the information associated with the user mobile device 70 whose use right is to be canceled (step S410). After the information associated with the user mobile device 70 (whose use right is to be canceled) is selected, the details of the information (such as all of the locks 60 whose use rights have been granted to the user mobile device 70) associated with the user mobile device 70 will be displayed. In this state, at least one of the locks may be selected to cancel the associated use right (step S411). The manager mobile device 68 sends a command to the user mobile device 70 to cancel the use right of the selected lock 60. Thus, the user mobile device 70 cannot unlock the selected lock 60 (step S412).

When the manager mobile device 68 executes the use right cancellation procedure (step S40) and selects a door access card 66 (step S402), the interface of the APP installed on the manager mobile device 68 will show the use right informations (of all of the locks) stored in the selected door access card 66. Then, at least one of the use right informations of all of the locks is selected (the selected lock whose use right is to be cancelled from the selected door access card 66, see step S404) for cancellation. In step S406, it is identified whether synchronization is successful. Specifically, when the manager mobile device 68 does not find the selected lock within the wireless communication range, the selected door access card 66 still has the use right to unlock the selected lock 60. Namely, the synchronization is not successful, such that the cancellation is not successful, see step S408. On the other hand, when the selected lock is found within the wireless communication range of the manager mobile device 68 and the synchronization is successfully executed, the information associated with the selected lock 60 is cancelled from the card ID information of the selected door access card 66 (step S412), such that the selected door access card 66 loses the use right of the selected lock 60.

After the manager mobile device 68 obtains the control authority, the APP installed on the manager mobile device 68 may execute a single authentication procedure (step S442) required for executing the unlocking procedure. After the manager mobile device 68 grants the use right of a lock 60 to a user mobile device 70, the user mobile device 70 may be defaulted to execute the single authentication procedure (step S442). Nevertheless, the manager mobile device 68 may use a changing access authentication procedure (step S44) to change the authentication procedure to be executed by the manager mobile device 68 and the user mobile device 70.

When it is desired to change the authentication procedure required for executing the unlocking procedure, the user may select one of three icons on the interface of the APP installed on the manager mobile device 68 and respectively representing single authentication (S442), double authentication (S444), and quick access (S446). For example, the user may select one of the single authentication, the double authentication, and quick access.

For example, the defaulted procedure of the manager mobile device 68 is the single authentication procedure. The manager mobile device 68 may be used to select one of the double authentication and the quick access (step S448). Specifically, after the access authentication procedure of the manager mobile device 68 is selected, the APP installed on the manager mobile device 68 requests the holder of the manager mobile device 68 to input the authentication identification information (hereinafter referred to as “authentication ID”). In step S450, it is identified whether the authentication is successful. The authentication ID may be but not limited to a fingerprint feature, a facial feature, or a password. After the new access authentication procedure (one of the double authentication and the quick access in this example) is selected, when the authentication ID is identified by the manager mobile device 68 as being incorrect, the manager mobile device 68 maintains the single authentication procedure (step S452). On the other hand, when the authentication ID is identified by the manager mobile device 68 as being correct, the manager mobile device 68 switches to the double authentication procedure (step S458).

The interface of the APP installed on the manager mobile device 68 may be used to select the user mobile device 70 whose access authentication procedure is to be changed (step S454). All of the locks (whose use rights have been granted to the selected user mobile device 70) are listed by the APP installed on the manager mobile device 68, such that one or more of the locks (whose access authentication procedure is to be changed) may be selected, and the new access authentication procedure may be selected. For example, the single authentication procedure of the selected user mobile device 70 is to be changed to the double authentication procedure or the quick access procedure, the new authentication procedure (such as the quick access procedure) is selected. In a non-restrictive example, the manager mobile device 68 uses Global System for Mobile Communications (GSM) to send a command to change the access authentication mode to the selected user mobile device 70. After reception of the command, the user mobile device 70 executes the procedure required for changing the access authentication procedure, such as change from the single authentication procedure to the double authentication procedure.

In a case that the access authentication procedure of each of the manager mobile device 68 and the user mobile device 70 is set to the quick access procedure, input of any password or biological feature is not required when using either of the manager mobile device 68 and the user mobile device 70 to execute the unlocking procedure. The to-be-unlocked lock 60 directly identifies whether the command from the manager mobile device 68 or the user mobile device 70 includes the unlocking authority to thereby decide whether to unlock or not. For example, when the manager mobile device 68 acquires the control authority of the lock 60, the manager mobile device 68 obtains the identification information of the lock 60 and stores the identification information in the manager mobile device 68 after encryption. The manager mobile device 68 set to the quick access procedure sends the unlocking command. The associated lock 60 receiving the unlocking command from the manager mobile device 68 decrypts the unlocking command to obtain the identification information of the lock 60. When the obtained lock identification information received by the lock 60 does not match with the identification information stored in the lock 60, the lock 60 will not execute the unlocking command. On the other hand, when the obtained lock identification information received by the lock 60 matches with the identification information stored in the lock 60, the lock 60 will execute the unlocking command.

When either of the manager mobile device 68 and the user mobile device 70 is set to the single authentication procedure, a single authentication information must be inputted when using the manager mobile device 68 or the user mobile device 70 to execute the unlocking procedure. For example, a facial feature must be inputted when the manager mobile device 68 executes the unlocking procedure, whereas a fingerprint feature must be inputted when the user mobile device 70 executes the unlocking procedure.

When either of the manager mobile device 68 and the user mobile device 70 is set to the double authentication procedure, two authentication informations must be inputted in sequence when using the manager mobile device 68 or the user mobile device 70 to execute the unlocking procedure. For example, a fingerprint feature and a password must be inputted in sequence when the manager mobile device 68 (e.g., of the type without facial recognition function) executes the unlocking procedure, and the facial feature must be inputted twice (or two facial features must be inputted) when the user mobile device 70 (e.g., of the type without the function of picking up fingerprints) executes the unlocking procedure. In another example, a fingerprint feature and a facial feature must be inputted in sequence by the manager mobile device 68.

When either of the manager mobile device 68 and the user mobile device 70 is set to the quick access procedure, no authentication information is required when using the manager mobile device 68 or the user mobile device 70 to execute the unlocking procedure.

It is noted that the lock 60 is preset to a normal mode in the lock controlling method according to the present invention, such that the lock 60 is normally in a locking state. When the inner operating device 64 of the lock 60 is operated, the latch 61 of the lock 60 can be retracted to permit opening of the door 59 regardless of whether the lock 60 is in the locking state or unlocking state. Nevertheless, when the lock 60 in the normal mode is in the locking state, operation of the outer operating device 62 of the lock 60 cannot retract the latch 61. Only when the lock 60 is in the unlocking state, the outer operating device 62 of the lock 60 can be operated to retract the latch 61 for opening the door 59.

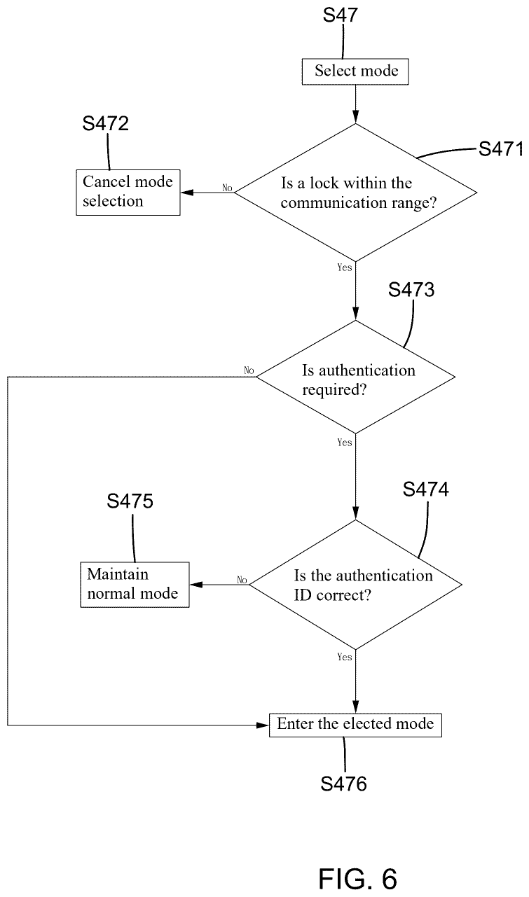

The APP installed on the manager mobile device 68 may be used to switch the lock 60 from the normal mode to a normally open mode or a do-not-disturb (hereinafter “dnd”) mode (mode selection procedure, step S47). With reference to FIG. 6, when the interface of the APP installed on the manager mobile device 68 is used to select the normally open mode or the dnd mode (FIG. 11 shows an example of the interface of the APP displayed on the manager mobile device 68). When there is no lock (whose control authority has been granted to the manager mobile device 68) in the wireless communication range of the manager mobile device 68 (step S471), the manager mobile device 68 will terminate the mode selection procedure (step S472).

In step S473, it is identified whether authentication is required. For example, when the manager mobile device 68 (which is set to a quick access procedure) executes the mode selection procedure and a lock 60 (whose control authority has been granted to the manager mobile device 68) is found in the wireless communication range of the manager mobile device 68, authentication is not required, and the manager mobile device 68 directly set the lock 60 to the selected normally open mode (or the selected dnd mode) (entering the selected mode, see step S476). When authentication is required, whether the inputted authentication ID is correct is identified in step S474. When the authentication ID is identified as being incorrect, the manager mobile device 68 remains in the normal mode (step S475). On the other hand, when the authentication ID is identified as being correct, the manager mobile device 68 enters the selected mode (step S476).

When the manager mobile device 68 (which is set to a single authentication procedure) executes the mode selection procedure and a lock 60 (whose control authority has been granted to the manager mobile device 68) is found in the wireless communication range of the manager mobile device 68, the APP installed on the manager mobile device 68 is used to guide input of an authentication ID (such as a fingerprint feature). When the authentication ID is identified as being incorrect, the manager mobile device 68 remains in the normal mode (step S475). On the other hand, when the authentication ID is identified as being correct, the manager mobile device 68 enters the selected mode (step S476).

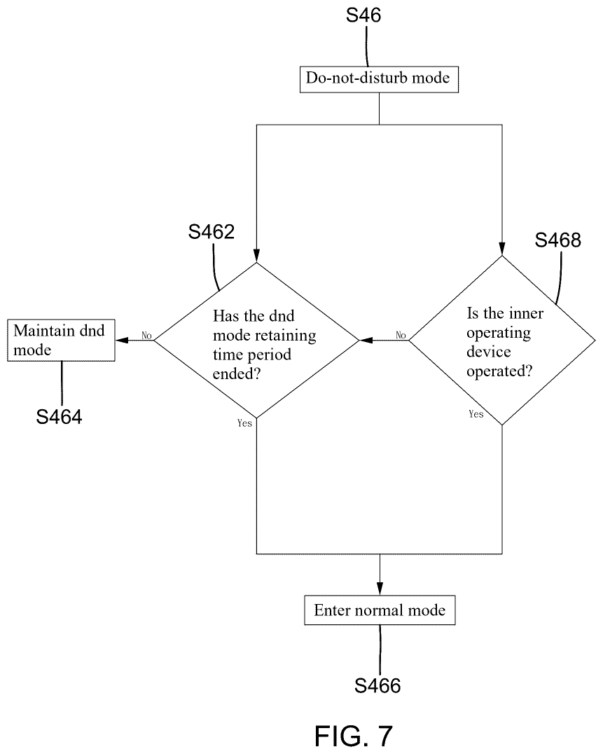

A dnd mode retaining time period is preset in the dnd mode. With reference to FIG. 7, in a case that the lock 60 enters the dnd mode (step S46), the lock 60 starts the countdown of the dnd mode retaining time period. In step S462, it is identified whether the preset dnd mode retaining time period ends. At the same time, operation of the inner operating device 64 of the lock 60 is detected (step S468). When the inner operating device 64 is not operated and the preset dnd mode retaining time period is not over, the lock 60 maintains the dnd mode (step S464). When the preset dnd mode retaining time period ends or the latch 61 is retracted under operation of the inner operating 64, the lock 60 returns from the dnd mode to the normal mode.

Given the lock 60 in the dnd mode, the lock 60 can be unlocked only when the manager mobile device 68 (granted with the control authority of the lock 60) executes the unlocking procedure. Namely, both the user mobile device 70 and the door access card 60 cannot be used to unlock the lock 60 even though the unlocking procedure is executed. Furthermore, the dnd mode retaining time can be changed by using the APP of the manager mobile device 68.

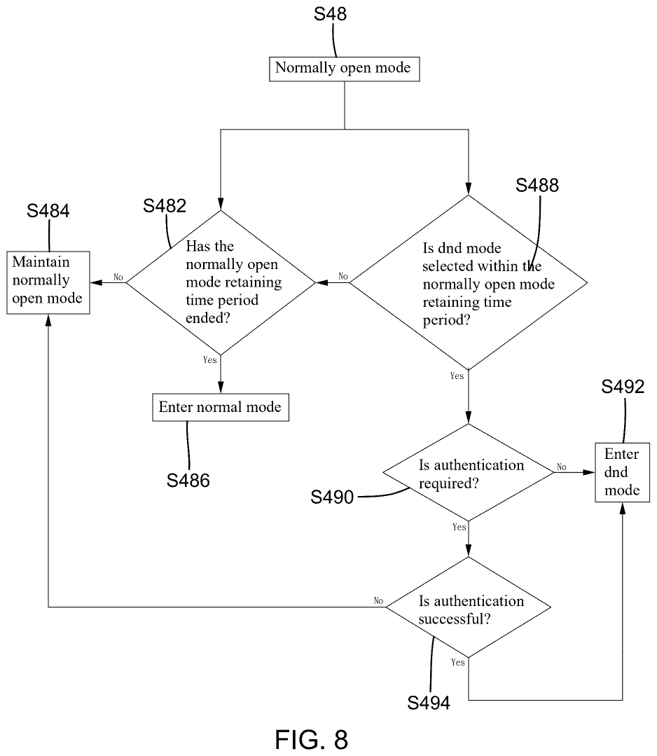

A normally open mode retaining time period is preset in the normally open mode. With reference to FIG. 8, in a case that the lock 60 enters the normally open mode (step S48), the lock 60 starts the countdown of the normally open mode retaining time period. In step S482, it is identified whether the preset normally open mode retaining time ends. At the same time, in step S488, whether the lock 60 is set to the dnd mode during the normally open mode retaining time period is detected. When the preset normally open mode retaining time period is not over and the lock 60 is not set to the dnd mode, the lock 60 maintains the normally open mode (step S484). When the preset normally open mode retaining time period ends and the lock 60 is not set to the dnd mode, the lock 60 returns from the normally open mode to the normal mode (step S486). When the normally open mode retaining time period is not over and the lock 60 is set by the manager mobile device 68 to the dnd mode, single authentication or double authentication is required (see step S490). When no authentication is required in step S490, the lock 60 enters the dnd mode. In step S494, it is identified whether the authentication is successful. When an authentication ID inputted in the single authentication procedure or at least one of two authentication IDs inputted in the double authentication procedure is identified as being incorrect (unsuccessful authentication), the lock 60 maintains the normally open mode (S484). When an authentication ID inputted in the single authentication procedure or both two authentication IDs inputted in the double authentication procedure is/are identified as being correct (successful authentication), the lock 60 switches from the normally open mode to the dnd mode (step S492).

The lock 60 in the normally open mode remains in the unlocking state, such that operation of either of the outer operating device 62 and the inner operating device 64 can retract the latch 61 to open the door 59 without using any one of the manager mobile device 68, the user mobile device 70, and the door access card 66.

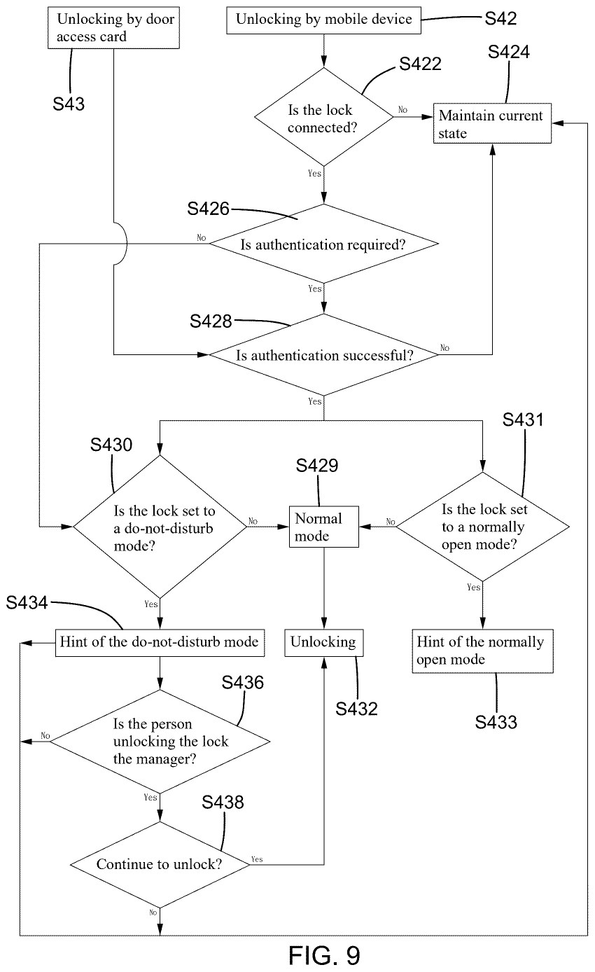

The manager mobile device 68 can execute the unlocking procedure to unlock the lock 60 in the normal mode or the dnd mode. With reference to FIG. 9, when the interface of the APP installed on the manager mobile device 68 is used to execute the unlocking procedure (step S42), the manager mobile device 68 searches whether a lock 60 is located within the wireless communication range of the manager mobile device 68. Specifically, in step S422, it is identified whether the lock 60 (whose control authority has been granted to the manager mobile device 68) is connected with the manager mobile device 68. If not, the lock 60 remains its current state. Namely, the lock 60 in the normal mode or the dnd mode remains in the locking state, whereas the lock 60 in the normally open mode remains in the unlocking state (step S424).

When the lock 60 (whose control authority or use right has been granted to the manager mobile device 68) is connected with the manager mobile device 68, the APP installed on the manager mobile device 68 (set to the quick access procedure) does not request input of any authentication ID, or the APP installed on the manager mobile device 68 (set to the single authentication procedure) requests input of an authentication ID, or the APP installed on the manager mobile device 68 (set to the double authentication procedure) requests twice input of authentication ID. Specifically, in step S426, it is identified whether authentication is required. In step S428, it is identified whether the authentication is successful. When an authentication ID inputted to the manager mobile device 68 (which is set to the single authentication procedure) or at least one of two authentication IDs inputted to the manager mobile device 68 (which is set to the double authentication procedure) is identified as being incorrect (unsuccessful authentication), the lock 60 in the normal mode or dnd mode remains in the locking state, whereas the lock 60 in the normally open mode remains in the unlocking state (maintaining the current state, see step S424).

When an authentication ID inputted to the manager mobile device 68 (which is set to the single authentication procedure) or both two authentication IDs inputted to the manager mobile device 68 (which is set to the double authentication procedure) is/are identified as being correct (successful authentication), or the manager mobile device 68 is set to the quick access procedure, the lock 60 connected with the manager mobile device 68 enters the dnd mode or the normally open mode. In step S430, it is identified whether the lock 60 is set to the dnd mode, and in step S431, it is identified whether the lock 60 is set to the normally open mode. When the lock 60 connected with the manager mobile device 68 is in the normal mode (neither the dnd mode nor the normally open mode, see S429), the lock 60 may execute the unlocking procedure, and the outer operating device 62 can be operated to retract the latch 61 for opening the door 59 (step S432).

When the lock is identified as being set to the dnd mode in step S430, the interface of the APP installed on the manager mobile device 68 gives a hint that the lock is in the dnd mode (step S434). In step S436, it is identified whether the person executing the unlocking procedure is the manager. If not, the lock 60 mains its current state. If yes, in step S438, the interface of the APP installed on the manager mobile device 68 asks the holder of the manager mobile device 68 whether to continue the unlocking procedure. If the holder decides not to continue the unlocking procedure, the lock 60 in the dnd mode remains in the locking state (S424). If the holder of the manager mobile device 68 decides to continue the unlocking procedure, the lock 60 in the dnd mode is unlocked (S432).

When the lock 60 is identified as being set to the normally open mode in step S431, the interface of the APP installed on the manager mobile device 68 gives a hint that the lock is in the normally open mode (step S433).

Still referring to FIG. 9, use of the user mobile device 70 to unlock the lock 60 is similar to that of the manager mobile device 68. When the user mobile device 70 is used to execute the unlocking procedure (step S42), the user mobile device 70 searches whether a lock 60 is located within the wireless communication range of the manager mobile device 68. Specifically, in step S422, it is identified whether the lock 60 (whose control authority has been granted to the user mobile device 70) is connected with the user mobile device 70. If not, the lock 60 remains its current state. Namely, the lock 60 in the normal mode or the dnd mode remains in the locking state, whereas the lock 60 in the normally open mode remains in the unlocking state (step S424).

When the lock 60 (whose control authority or use right has been granted to the user mobile device 70) is connected with the manager mobile device 68, the APP installed on the user mobile device 70 (set to the quick access procedure) does not request input of any authentication ID, or the APP installed on the user mobile device 70 (set to the single authentication procedure) requests input of an authentication ID, or the APP installed on the user mobile device 70 (set to the double authentication procedure) requests twice input of authentication ID. Specifically, in step S426, it is identified whether authentication is required. In step S428, it is identified whether the authentication is successful. When an authentication ID inputted to the user mobile device 70 (which is set to the single authentication procedure) or at least one of two authentication IDs inputted to the user mobile device 70 (which is set to the double authentication procedure) is identified as being incorrect (unsuccessful authentication), the lock 60 in the normal mode or dnd mode remains in the locking state, whereas the lock 60 in the normally open mode remains in the unlocking state (maintaining the current state, see step S424).

When an authentication ID inputted to the user mobile device 70 (which is set to the single authentication procedure) or both two authentication IDs inputted to the user mobile device 70 (which is set to the double authentication procedure) is/are identified as being correct (successful authentication), or the user mobile device 70 is set to the quick access procedure, the lock 60 connected with the user mobile device 70 enters the dnd mode or the normally open mode. In step S430, it is identified whether the lock 60 is set to the dnd mode, and in step S431, it is identified whether the lock 60 is set to the normally open mode. When the lock 60 connected with the user mobile device 70 is in the normal mode (neither the dnd mode nor the normally open mode, see S 429), the lock 60 may execute the unlocking procedure, and the outer operating device 62 can be operated to retract the latch 61 for opening the door 59 (step S432).

When the lock is identified as being set to the dnd mode in step S430, the interface of the APP installed on the user mobile device 70 gives a hint that the lock 60 is in the dnd mode (step S434), and the lock 60 in the dnd mode remains in the locking state. Steps S436 and S438 in FIG. 9 are skipped when the user mobile device 70 is used to execute the unlocking procedure.

When the lock 60 is identified as being set to the normally open mode in step S431, the interface of the APP installed on the user mobile device 70 gives a hint that the lock is in the normally open mode (step S433).

Still referring to FIG. 9, use of the door access card 66 to unlock the lock 60 is simpler than that of the user mobile device 70. When the door access card 66 is used to execute the unlocking procedure (step S43), the door access card 66 is placed near to the outer operating device 62 of the lock 60. The outer operating device 62 reads the card ID information of the door access card 66 to perform authentication. In step S428, it is identified whether the authentication is successful. When the card ID information is identified as being incorrect (unsuccessful authentication), the lock 60 in the normal mode or dnd mode remains in the locking state, whereas the lock 60 in the normally open mode remains in the unlocking state (maintaining the current state, see step S424).

When the card ID information of the door access card 66 identified as being correct (successful authentication) and the lock 60 connected with the door access card 66 is in the normal mode, the lock 60 executes the unlocking procedure, such that the outer operating device 62 can be operated to retract the latch 61 for opening the door 59. For example, the card ID information of a door access card 66 (which is granted with the use right of the lock 60) is stored in the lock 60. Thus, when the lock 60 executes the unlocking procedure and reads the card ID information stored in a door access card 66 placed near the outer operating device 62 of the lock 60, the card ID information stored in the door access card 66 is compared with the card ID information stored in the lock 60 to proceed with the authentication procedure. In step S430, it is identified whether the lock 60 is set to the dnd mode, and in step S431, it is identified whether the lock 60 is set to the normally open mode. When the lock 60 is in the normal mode (neither the dnd mode nor the normally open mode, see S429), the lock 60 may execute the unlocking procedure, and the outer operating device 62 can be operated to retract the latch 61 for opening the door 59 (step S432).

When the card ID information of the door access card 66 identified as being correct (successful authentication) and the lock 60 is identified as being set to the dnd mode in step S430, the lock 60 generates sound and/or light to indicate the dnd mode, and the lock 60 remains in the locking state. (step S434). Steps S436 and S438 in FIG. 9 are skipped when the door access card 66 is used to execute the unlocking procedure.

When the lock 60 is identified as being set to the normally open mode in step S431, the lock 60 gives a hint (by sound and/or light) that the lock 60 is in the normally open mode (step S433).

It is noted that after the lock 60 enters the normally open mode, the lock 60 will not give a hint (indicating the normally open mode) when the door access card 66 is identified by the lock 60 as being incorrect. Nevertheless, the lock 60 will generate sound and/or light to indicate that the door access card 66 does not have the use right of the lock 60 and, thus, cannot unlock the lock 60.

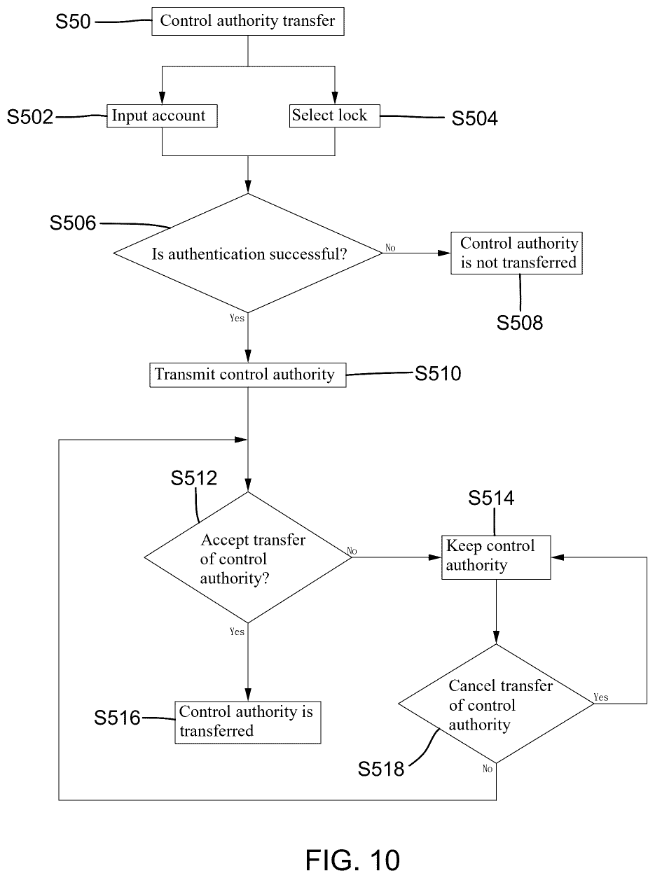

With reference to FIG. 10, the manager mobile device 68 (which has been granted with the control authority of the lock 60) may be used to transfer the control authority to another mobile device (the APP has been installed on the another mobile device which has completed the registration procedure). For example, the manager mobile device 68 may transfer the control authority of the lock 60 to a user mobile device 70.

Specifically, when a holder of the manager mobile device 68 selects to execute the control authority transfer procedure (step S50), the APP installed on the manager mobile device 68 requests input of the account name of the another mobile device (to which the control authority of a lock will be transferred) (step S502). Furthermore, informations of all locks (whose control authorities have been granted to the manager mobile device 68) are provided and may be selected by the holder of the manager mobile device 68 (step S504). Then, the APP installed on the manager mobile device 68 requests input of an authentication ID for execution of an authentication procedure. It is noted that the authentication ID must be inputted regardless of the mode of the authentication procedure of the manager mobile device 68 (the quick access procedure, single authentication procedure, or double authentication procedure). Specifically, in step S506, it is identified whether the authentication is successful. If not, the control authority is not transferred (step S508). If yes, the control authority is transmitted to the mobile device with the associated account name (step S510), such as via GSM.

In a case that a user mobile device 70 receives information (associated with transfer of control authority of the lock 60) from the manager mobile device 68, the APP installed on the user mobile device 70 will pop up a window on the screen of the user mobile device 70. In step S512, it is identified whether transfer of the control authority is accepted. When the holder of the user mobile device 70 agrees with transfer of the control authority, the transfer of control authority is successfully transferred from the manager mobile device 68 to the user mobile device 70 (step S516). On the other hand, when the holder of the user mobile device 70 does not agree with transfer of the control authority or has not agreed with transfer of the control authority, the manager mobile device 68 keeps the control authority (step S514). Furthermore, while the holder of the user mobile device 70 does not agree with transfer of the control authority or has not agreed with transfer of the control authority, the holder of the manager mobile device 68 can determine whether to cancel transfer of control authority. When the holder of the manager mobile device 68 determines to cancel transfer of control authority, the manager mobile device 68 still keeps the control authority of the lock 60 (S514). On the other hand, when the holder of the manager mobile device 68 decides to continue transfer of control authority, the holder of the user mobile device 70 may decide whether to accept transfer of control authority (step S512).

The lock controlling method according to the present invention has been described in detail. Thus, it can be appreciated that the technical features according to the present invention includes at least the following advantages. Firstly, the normally open mode provided in the lock controlling method according to the present invention enables the lock 60 to maintain the unlocking state for a period of time, such that an older person or a solitary in a house may seek help, and an ambulance technician or police may rapidly enter the house to provide timely assistance.

The dnd (do-not-disturb) mode provided in the lock controlling method according to the present invention permits a lock 60 to be unlocked only when the unlocking procedure is executed by a manager mobile device 68 granted with the control authority of the lock 60. Thus, when the holder of the manager mobile device 68 needs privacy, the lock 60 cannot be unlocked by devices other than the manager mobile device 68.

Given the lock 60 in the dnd mode, after the inner operating device 64 is operated, the lock 60 will return to the normal mode. Thus, the holder of the manager mobile device 68 can simply and rapidly release the dnd mode of the lock 60 and restores the normal mode.

By using the lock controlling method according to the present invention to grant the use right of the lock 60 to the door access card 66, the outer operating device 62 of the lock 60 may directly read the card ID information of the door access card 66, such that the use right of the lock 60 (unlocking the lock 60) can be granted to the door access card 66 without using a computer and a card reader, which is more convenient to grant the use right to the door access card 66.

Furthermore, the lock reading the door access card 66 is not limited to be the lock whose use right is to be granted to the door access card 66. Furthermore, it is not necessary to use the manager mobile device 68 to transmit the card ID information of the door access card 66 to the lock 60 (whose use right is to be granted to the door access card 66) at the first time. For example, after reading the card ID information of the door access card 66, the manager mobile device 68 can be connected with the lock 60 within the communication range of the lock 60 (whose use right is to be granted to the door access card 66) within an hour and then transmit the card ID information of the door access card 66 to the lock 60, which is convenient to the granting of the use right of the door access card 66.

Transfer of the control authority of the lock 60 (whose control authority has been granted to the manager mobile device 68) according to the present invention is relatively convenient, and the manager mobile device 68 can still cancel transfer of control authority before the holder of the mobile device agrees with the transfer, providing certain fault-tolerance during the control authority transfer operation.

Now that the basic teachings of the present invention have been explained, many extensions and variations will be obvious to one having ordinary skill in the art. For example, the lock controlling method according to the present invention is not limited to be carried out on only one lock 60, only one manager mobile device 68, only one user mobile device 70, or only one door access card 66. For example, the lock 60, the user mobile device 70, or the door access card 66 may be plural.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. A lock controlling method comprising:
using a manager mobile device to obtain a control authority of a lock to permit execution of an unlocking procedure on the lock, wherein the lock is preset to a normal mode and a locking state, wherein when the lock is not in an unlocking state, operation of an outer operating device of the lock is unable to retract a latch of the lock, and the latch is retractable by operating an inner operating device of the lock; and
using the manager mobile device to execute a mode selection procedure permitting the manager mobile device to be switched from the normal mode to a normally open mode, wherein the manager mobile device is used to connect with the lock whose control authority has been granted to the manager mobile device, wherein the mode selection procedure is canceled when connection between the manager mobile device and the lock is not established, wherein when connection between the manager mobile device and the lock is established, the manager mobile device 68 is usable to set the lock to one of the normal mode and the normally open mode,
wherein when the lock is set to the normally open mode, the lock starts countdown of a normally open mode retaining time period, wherein when the normally open mode retaining time period is not over, the lock0 maintains the normally open mode and the unlocking state, wherein when the normally open mode retaining time period ends, the lock returns from the normally open mode to the normal mode.

2. The lock controlling method as claimed in claim 1, wherein the mode selection procedure further includes a do-not-disturb (dnd) mode, permitting the manager mobile device to switch the lock from the normal mode to one of the dnd mode and the normally open mode, wherein when the lock is set to the dnd mode and is in the locking state, the lock starts countdown of a dnd mode retaining time period, wherein when the dnd mode retaining time period is not over, the lock in the dnd mode only permits the manager mobile device to execute the unlocking procedure for unlocking the lock, and wherein when the dnd mode retaining time period ends, the lock returns to the normal mode.

3. The lock controlling method as claimed in claim 2, further comprising using a door access card to execute the unlocking procedure, wherein the door access card is granted with a use right of the lock, wherein the lock reads a door access card identification information of the door access card and identifies whether the door access card identification information of the door access card is correct, wherein when the door access card identification information of the door access card is incorrect and the lock is in either of the normal mode and the dnd mode, the lock remains in the locking state, wherein when the door access card identification information of the door access card is incorrect and the lock is in the normally open mode, the lock remains in the unlocking state and gives a hint by sound and/or light to indicate that the door access card identification information of the door access card is identified as being incorrect, wherein when the door access card identification information of the door access card is correct and the lock is in the normal mode, the lock is unlocked, wherein when the door access card identification information of the door access card is correct and the lock is in the dnd mode, the lock remains in the locking state, and wherein when the door access card identification information of the door access card is correct and the lock is in the normally open mode, the lock gives a hint by sound and/or light to indicate the normally open mode and remains in the unlocking state.

4. The lock controlling method as claimed in claim 3, wherein granting the use right includes:
using the manager mobile device to grant the use right to the door access card;
setting a name for the door access card;
using the manager mobile device to select the lock whose use right is to be granted to the door access card;
setting a time period of the use right to be granted to the door access card;
using the manager mobile device to select the lock to read the door access card, such that the lock selected to read the door access card generates a hint, wherein when the door access card is placed near the lock, the lock generating the hint reads the door access card identification information of the door access card and transmits the door access card identification information of the door access card to the manager mobile device;
using the manager mobile device to proceed with a synchronization procedure on the lock whose use right is to be granted, wherein the door access card does not obtain the use right of the lock before the synchronization procedure is completed, and wherein the door access card obtains the use right of the lock only after the synchronization procedure is completed.

5. The lock controlling method as claimed in claim 4, further comprising:
using the manager mobile device to execute a use right cancellation procedure;
selecting the door access card, wherein a plurality of door access card identification informations associated with a plurality of locks is stored in the door access card;
selecting one of the plurality of locks whose door access card identification information is to be cancelled;
identifying whether the selected lock is within a wireless communication range of the manager mobile device, wherein when the selected lock is not within the wireless communication range of the manager mobile device, the door access card still owns the use right of the selected lock, and wherein when the selected lock is within the wireless communication range of the manager mobile device, is connected with the manager mobile device, and is synchronized with the manager mobile device, the use right of the selected lock is cancelled from the door access card.

6. The lock controlling method as claimed in claim 2, further comprising:
using a user mobile device to execute the unlocking procedure, wherein the user mobile device is granted with a use right of the lock;
wherein with the user mobile device not connected with the lock, the lock remains in the locking state when in either of the normal mode and the dnd mode or remains in the unlocking state when in the normally open mode,
wherein with the user mobile device connected with the lock and with the user mobile device set to a single authentication procedure in which input of an authentication identification information is requested, when identification of the inputted authentication identification information is unsuccessful, the lock remains in the unlocking state when in either of the normal mode and the dnd mode or remains in the unlocking state when in the normally open mode,
wherein when the inputted authentication identification information is identified as being correct or the authentication identification information is not required, the lock is switched to the unlocking state when in the normal mode, or remains in the unlocking state and gives a hint to indicate the unlocking state when in the normally open mode, or remains in the locking state when in the dnd state.

7. The lock controlling method as claimed in claim 6, wherein granting the use right to the user mobile device includes:
using the user mobile device to complete registration of an account of the user mobile device;
using the manager mobile device to input an account or using the manager mobile device to scan a QR code displayed by the user mobile device, wherein when the account inputted by the manager mobile device or the QR code scanned by the manager mobile device is incorrect, the use right of the lock is not granted to the user mobile device, wherein when the account inputted by the manager mobile device or the QR code scanned by the manager mobile device is correct, the manager mobile device grants the use right of the lock to the user mobile device.

8. The lock controlling method as claimed in claim 7, further comprising:
using the manager mobile device to execute a control authority transfer procedure including:
inputting an account name of another mobile device to which the control authority is to be transferred;
selecting a lock whose control authority is to be transferred;
requesting input of an authentication identification information for execution of an authentication procedure, wherein when the authentication is unsuccessful, the control authority is not transferred to the another mobile device, wherein when the authentication is successful, the control authority is transmitted to the another mobile device;
wherein when a holder of the user mobile device does not agree with transfer of the control authority or has not agreed with transfer of the control authority, the manager mobile device keeps the control authority of the selected lock,
wherein when the holder of the user mobile device agrees with transfer of the control authority, the transfer of control authority of the selected lock is successfully transferred from the manager mobile device to the user mobile device, and the lock loses the control authority of the selected lock.

9. The lock controlling method as claimed in claim 2, wherein the manager mobile device obtains the control authority of the lock by:
using the manager mobile device to select a control authority adding procedure;
operating the lock to enter a state permitting access to the control authority;
using the manager mobile device to search whether the lock is within the wireless communication range of the manager mobile device, wherein the control authority of the lock is not granted to the manager mobile device when the lock is not within the wireless communication range;
wherein when the lock is within the wireless communication range, the manager mobile device is used to select the lock whose control authority is to be granted to the manager mobile device, wherein the manager mobile device is used to input an identification number, wherein when the inputted identification number does not match with a unique identification number of the lock, the control authority is not granted to the manager mobile device, and wherein when the when the inputted identification number matches with the unique identification number of the lock, the control authority is granted to the manager mobile device.

10. The lock controlling method as claimed in claim 9, further comprising:
using the manager mobile device to execute the unlocking procedure includes:
using the manager mobile device to identify whether the lock is connected with the manager mobile device, wherein when the lock is not connected with the manager mobile device, the lock remains in the locking state when in either of the normal mode and the dnd mode or remains in the unlocking state when in the normally open mode,
wherein when the lock is connected with the manager mobile device which is set to require input of an authentication information, the manager mobile device is used to input the authentication information, wherein when the inputted authentication information is identified as being incorrect, the lock remains in the locking state when in either of the normal mode and the dnd mode or remains in the unlocking state when in the normally open mode,
wherein when the inputted authentication information is identified as being correct and the lock is in the normal mode, the manager mobile device transmits a control signal to the lock, wherein when the lock identifies that the control signal is correct, the lock is switched to the unlocking state,
wherein when the inputted authentication information is identified as being correct and the lock is in the dnd mode, the manager mobile device gives a hint to indicate that the lock is in the dnd mode, and the manager mobile device requests input of determination of whether to continue the execution of the unlocking procedure, wherein when it is determined to continue the execution of the unlocking procedure, the lock is switched to the unlocking state, wherein when it is determined not to continue the execution of the unlocking procedure, the lock remains the locking state,
wherein when the inputted authentication information is identified as being correct and the lock is in the normally open mode, the manager mobile device gives a hint to indicate that the lock is in the normally open mode.

11. A lock controlling method comprising:
using a manager mobile device to obtain a control authority of a lock to permit execution of an unlocking procedure on the lock, wherein the lock is preset to a normal mode and a locking state, wherein when the lock is not in an unlocking state, operation of an outer operating device of the lock is unable to retract a latch of the lock, and the latch is retracted by operating an inner operating device of the lock; and
using the manager mobile device to execute a mode selection procedure permitting the manager mobile device to be switched from the normal mode to a do-not-disturb (dnd) mode, wherein the manager mobile device is used to connect with the lock whose control authority has been granted to the manager mobile device, wherein the mode selection procedure is canceled when connection between the manager mobile device and the lock is not established, wherein when connection between the manager mobile device and the lock is established, the manager mobile device is usable to set the lock to one of the normal mod and the dnd mode,
wherein when the lock is set to the dnd mode and remains in the locking state, the lock starts countdown of a dnd mode retaining time period, wherein when the dnd retaining time period is not over, the lock maintains the dnd mode and only permits execution of the unlocking procedure by the manager mobile device, wherein when the dnd mode retaining time period ends, the lock returns from the dnd mode to the normal mode.

12. The lock controlling method as claimed in claim 11, further comprising using a door access card to execute the unlocking procedure, wherein the door access card is granted with a use right of the lock, wherein the lock reads a door access card identification information of the door access card and identifies whether the door access card identification information of the door access card is correct, wherein when the door access card identification information of the door access card is incorrect and the lock is in either of the normal mode and the dnd mode, the lock remains in the locking state, wherein when the door access card identification information of the door access card is correct and the lock is in the normal mode, the lock is switched to the unlocking state, and wherein when the door access card identification information of the door access card is correct and the lock is in the dnd mode, the lock remains in the locking state.

13. The lock controlling method as claimed in claim 11, further comprising:
using a user mobile device to execute the unlocking procedure, wherein the user mobile device is granted with a use right of the lock,
wherein with the user mobile device not connected with the lock, the lock remains in the locking state when in either of the normal mode and the dnd mode or remains in the unlocking state when in the normally open mode,
wherein with the user mobile device connected with the lock and with the user mobile device set to a single authentication procedure in which an authentication identification information is to be inputted, when identification of the inputted authentication identification information is unsuccessful, the lock remains in the locking state when in either of the normal mode and the dnd mode,
wherein when the inputted authentication identification information is identified as being correct or the authentication identification information is not required, the lock is switched to the unlocking state when in the normal mode or remains in the locking state when in the dnd state.

14. A lock controlling method comprising:
using a manager mobile device to grant a control authority of a first lock and a control authority of a second lock;
using the manager mobile device to grant a use right to a door access card;
setting a name for the door access card;
using the manager mobile device to select at least one of the first lock and the second lock whose control authority is to be granted to the door access card;
using the manager mobile device to select the first lock or the second lock as a device for reading a door access card identification information of the door access card, wherein the selected one of the first and second locks gives a hint indicative of a result of selection, wherein when the door access card is near the selected one of the first and second locks, the selected one of the first and second locks reads the door access card identification information of the door access card and transmits the door access card identification information of the door access card to the manager mobile device;
using the manager mobile device to proceed with a synchronization procedure on at least one of the first and second locks whose use right is to be granted, wherein the door access card is granted with the use right of at least one of the first and second locks only when the synchronization procedure is completed on the manager mobile device and the at least one of the first and second locks.

15. The lock controlling method as claimed in claim 14, further comprising:
using the manager mobile device to execute a mode selection procedure permitting the manager mobile device to be switched from the normal mode to a normally open mode or a do-not-disturb (dnd) mode, wherein the manager mobile device is used to connect with one of the first and second locks whose control authority has been granted to the manager mobile device, wherein the mode selection procedure is canceled when connection between the manager mobile device and the one of the first and second locks is not established, wherein when connection between the manager mobile device and the one of the first and second locks is established, the manager mobile device is usable to switch the one of the first and second locks from the normal mode to one the normally open mode and the dnd mode,
wherein with the first and second locks set to the normal mode, when the first and second locks are not in an unlocking state, operation of an outer operating device of either of the first and second locks is unable to retract a latch of a respective one of the first and second locks, and the latch is retractable by operating an inner operating device of the respective one of the first and second locks;
wherein when one of the first and second locks is set to the normally open mode, the one of the first and second locks starts countdown of a normally open mode retaining time period, wherein when the normally open mode retaining time period is not over, the one of the first and second locks maintains the normally open mode, wherein when the normally open mode retaining time period ends, the one of the first and second locks returns from the normally open mode to the normal mode,
wherein when one of the first and second locks is set to the dnd mode, the one of the first and second locks starts countdown of a dnd mode retaining time period, wherein when the dnd mode retaining time period is not over, the one of the first and second locks maintains the dnd mode, wherein when the dnd mode retaining time period ends, the one of the first and second locks returns from the dnd mode to the normal mode,
wherein when the door access card is used to execute an unlocking procedure, the selected one of the first and second locks reads and identifies the door access card identification information of the door access card,
wherein when the door access card identification information of the door access card is identified as being correct and the selected one of the first and second locks is set to the normal mode, the selected one of the first and second locks is switched to the unlocking state, such that the latch of the selected one of the first and second locks is retractable by operating either of the outer operating device and the inner operating device of the selected one of the first and second locks,
wherein when the door access card identification information of the door access card is identified as being correct and the selected one of the first and second locks is set to the dnd mode, operation of the outer operating device of the selected one of the first and second locks is unable to retract the latch of the selected one of the first and second locks, but operation of the inner operating device retracts the latch of the selected one of the first and second locks,
wherein when the door access card identification information of the door access card is identified as being correct and the selected one of the first and second locks is set to the normally open mode, the selected one of the first and second locks generates sound and/or light to indicate that the selected one of the first and second locks is in the normally open mode, wherein the latch of the selected one of the first and second locks is retractable by operating either of the outer operating device and the inner operating device of the selected one of the first and second locks.

16. The lock controlling method as claimed in claim 15, wherein the
using the manager mobile device to execute the unlocking procedure includes:
using the manager mobile device to identify whether one of the first and second locks is connected with the manager mobile device, wherein when the selected one of the first and second locks is not connected with the manager mobile device, the one of the first and second locks remains in the locking state when in either of the normal mode and the dnd mode or remains in the unlocking state when in the normally open mode,
wherein when the one of the first and second locks is connected with the manager mobile device which is set to require input of an authentication information, the manager mobile device is used to input the authentication information, wherein when the inputted authentication information is identified as being incorrect, the one of the first and second locks remains in the locking state when in either of the normal mode and the dnd mode or remains in the unlocking state when in the normally open mode,
wherein when the inputted authentication information is identified as being correct and the one of the first and second locks is in the normal mode, the manager mobile device transmits a control signal to the one of the first and second locks, wherein when the lock identifies that the control signal is correct, the one of the first and second locks is switched to the unlocking state,
wherein when the inputted authentication information is identified as being correct and the one of the first and second locks is in the dnd mode, the manager mobile device gives a hint to indicate that the one of the first and second locks is in the dnd mode, and the manager mobile device requests input of determination of whether to continue the execution of the unlocking procedure, wherein when it is determined to continue the execution of the unlocking procedure, the manager mobile device sends a control signal to the one of the first and second locks, wherein the one of the first and second locks is switched to the unlocking state when the control signal is identified as being correct, wherein when it is determined not to continue the execution of the unlocking procedure, the one of the first and second locks in the dnd mode remains the locking state,
wherein when the inputted authentication information is identified as being correct and the one of the first and second locks is in the normally open mode, the manager mobile device gives a hint to indicate that the one of the first and second locks is in the normally open mode.
